(19) United States
(12) Patent Application Publication
(10) Pub. No.: US 2007/0241899 A1
(43) Pub. Date: Oct. 18, 2007

(54) Burglarproof sensor for fragile object

(76) Inventor: Chen Lu Wang, Waipu Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/405,400

(22) Filed: Apr. 18, 2006

(51) Int. Cl. G08B 13/14

(52) U.S. Cl. 340/568.2

(57) ABSTRACT

A burglarproof sensor for fragile object includes a sensing circuit formed on the fragile object and having a first electrode and a second electrode. A sensor is connected to the first electrode and the second electrode to form a close circuit. An alarm is electrically connected to the sensor. The sensing circuit is broken and opened when the fragile object is come to pieces due to a crash formed by a flying object. The sensor senses the opened sensing circuit and transmits a signal to the alarm. The alarm lights or sounds to warn the guards for achieving a burglarproof objective when receiving the signal from the sensor.

### BACKGROUND OF THE INVENTION

1. Field of the Invention

The present invention relates to a burglarproof sensor, and more particularly to a burglarproof sensor for fragile object, such as a flat piece glass or acrylic resin.

2. Description of Related Art

A conventional glass burglarproof sensor in accordance with the prior art shown in FIG. 6 comprises vibrating sensor (50) attached to a corner of a glass (10′) and electrically connected to an alarm (30′). The vibrating sensor (50) quickly brings a signal and transmits the signal to the alarm (30′) via an electric cable (60) that is electrically connected to the vibrating sensor (50) and the alarm (30′) for warning the guards and achieving a burglarproof effect when the glass (10′) is broken or loads an unexpected strike. However, the conventional glass burglarproof sensor is switched by sensing vibration. Consequently, the glass may be vibrated and the alarm (30′) will be erroneously detonated by a stiff wind or an error contact from the guards. As a result, error rate of the conventional glass burglarproof sensor is high.

The present invention has arisen to mitigate and/or obviate the disadvantages of the conventional glass burglarproof sensor.

### SUMMARY OF THE INVENTION

The main objective of the present invention is to provide an improved burglarproof sensor for fragile object that can reduces the error rate.

To achieve the objective, the burglarproof sensor in accordance with the present invention comprises a sensing circuit formed on the fragile object and having a first electrode and a second electrode. A sensor is connected to the first electrode and the second electrode to form a close circuit. An alarm is electrically connected to the sensor. The sensing circuit is broken and opened when the fragile object is come to pieces due to a crash formed by a flying object. The sensor senses the opened sensing circuit and transmits a signal to the alarm. The alarm lights or sounds to warn the guards for achieving a burglarproof objective when receiving the signal from the sensor.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a burglarproof sensor for fragile object in accordance with the present invention;

FIG. 2 is a front plan view of the burglarproof sensor for fragile object of the present invention;

FIG. 3 is a flow chart of the burglarproof sensor for fragile object of the present invention;

FIG. 4 is a circuit diagram of the burglarproof sensor for fragile object of the present invention;

FIG. 5 is an operational view of the burglarproof sensor for fragile object of the present invention; and

FIG. 6 is a perspective view of a conventional glass burglarproof sensor in accordance with the prior art.

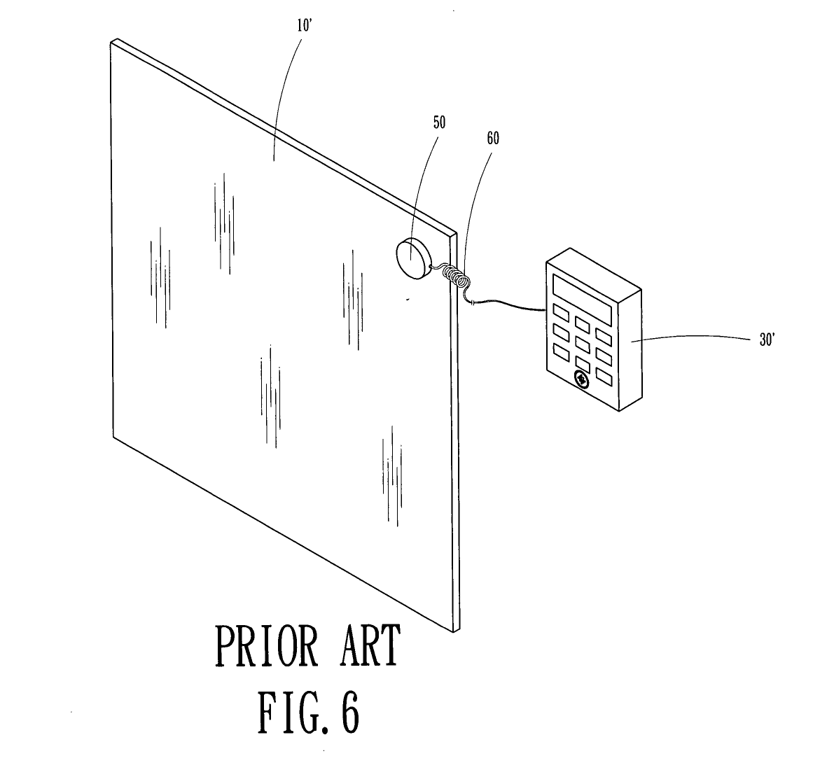

### DETAILED DESCRIPTION OF THE INVENTION

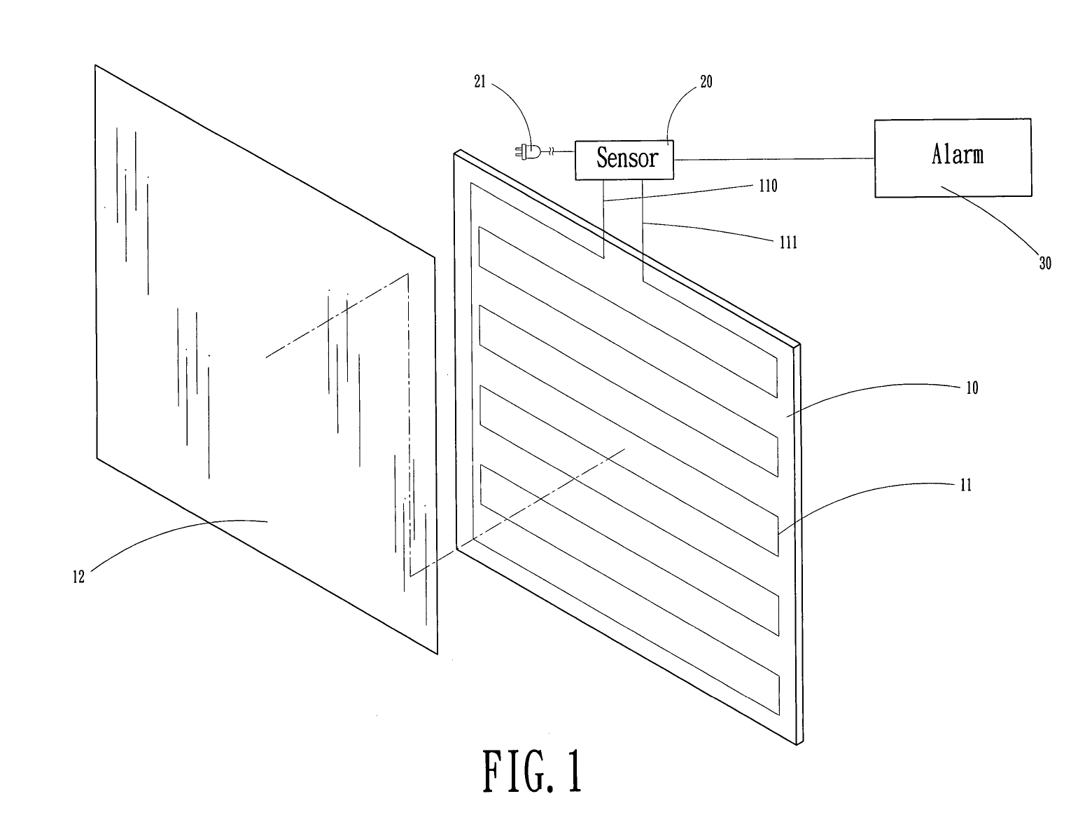

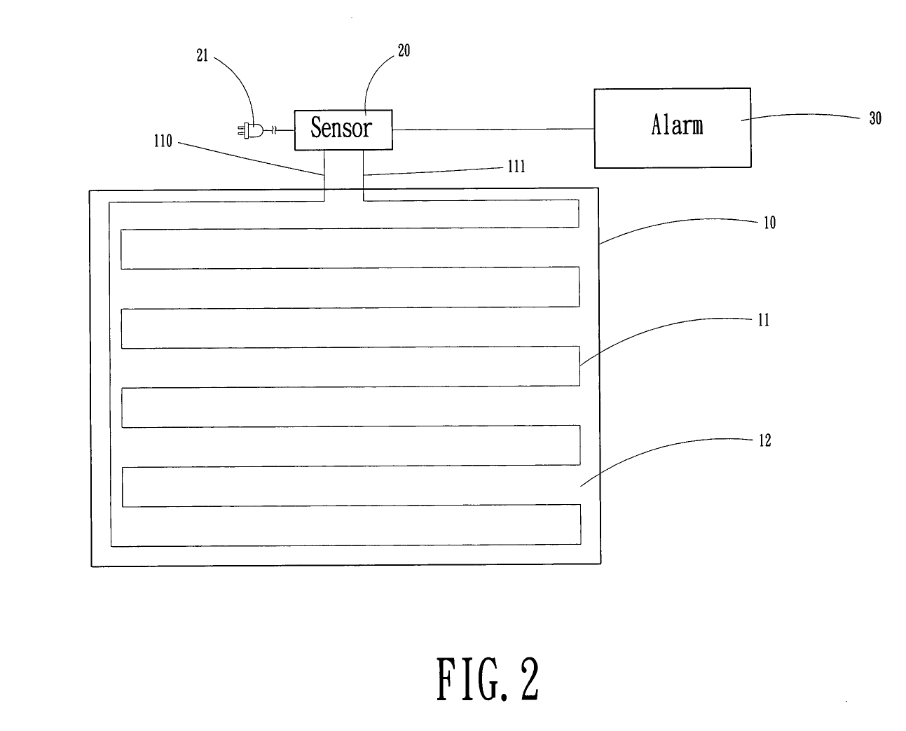

Referring to the drawings and initially to FIGS. 1-3, a burglarproof sensor for fragile object in accordance with the present invention comprises a sensing circuit (11) adapted to be formed on a fragile object (10), such as a flat piece glass or acrylic resin. In the preferred embodiment of the present invention, the sensing circuit (11) is formed with indium oxide that is achromatic chemical material and the sensing circuit (11) is formed on the fragile object (10) by plating, evaporation, sputtering or printing. The sensing has a first electrode (110) and a second electrode (111) respectively and electrically connected to a sensor (20) for forming a closed circuit. The fragile object (10) has a transparent film (12) covered thereon for protecting the sensing circuit (11).

The sensor (20) has an input (21) extending therefrom and adapted to be connected to a power source (not shown). The sensor (20) includes a voltage regulator (22), a power indicator (23), a voltage level comparator (24), a shunt regular push-pull (25), an inverter (26), a load circuit (27), a trigger circuit (28) and a switching circuit (29) disposed therein and electrically connected to one another for processing the signal from the sensing circuit (11).

An alarm (30) is electrically connected to the switching circuit (29) of the sensor (20).

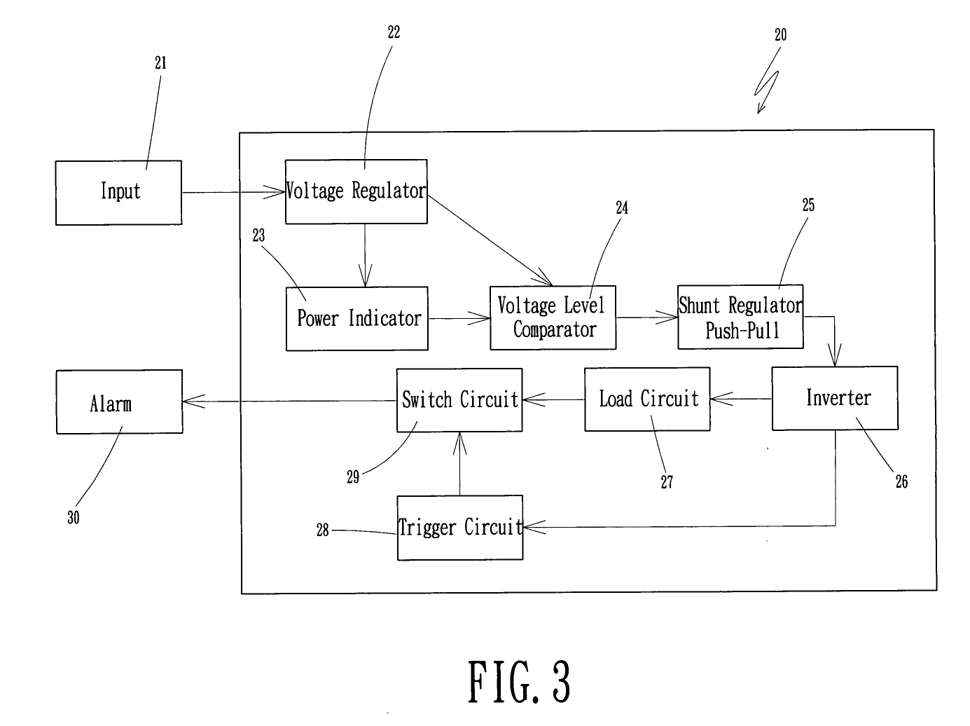

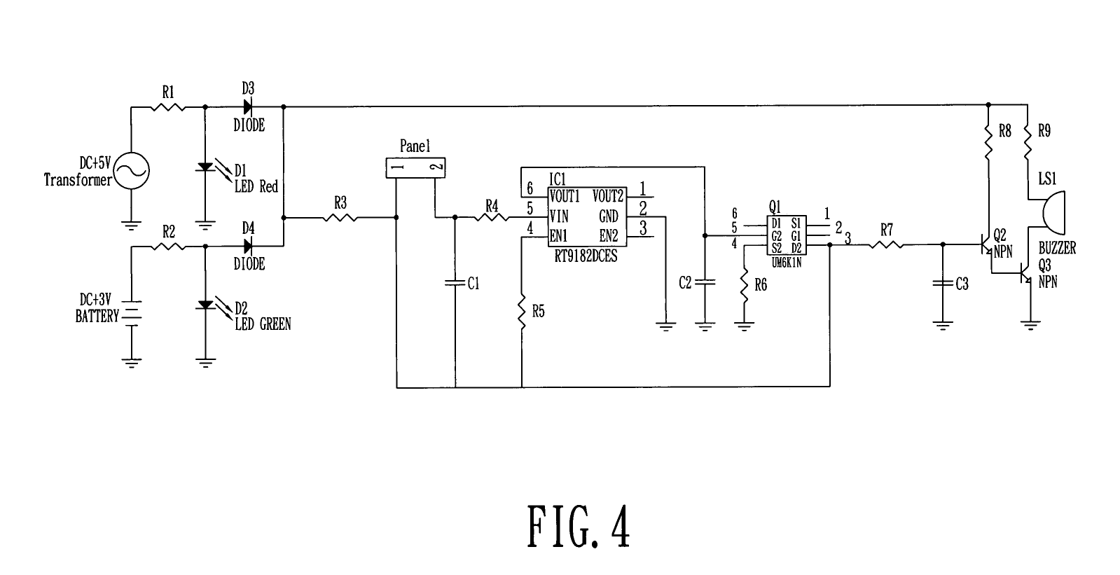

With reference to FIGS. 3 and 4, the input (21) is electrically connected to the voltage regulator (22) and the voltage regular (22) is electrically connected to the power indicator (23) and voltage level comparator (24). The power indicator (23) is electrically connected to the voltage level comparator (24) and the voltage level comparator (24) is electrically connected to the shunt regulator push-pull (25). The shunt regulator push-pull (25) is electrically connected to the inverter (26) and the inverter (26) is electrically connected to the load circuit (27) and the trigger circuit (28). The load circuit (27) and the trigger circuit (28) are respectively electrically connected to the switching circuit (29) and the switching circuit (29) is electrically connected to the alarm (30).

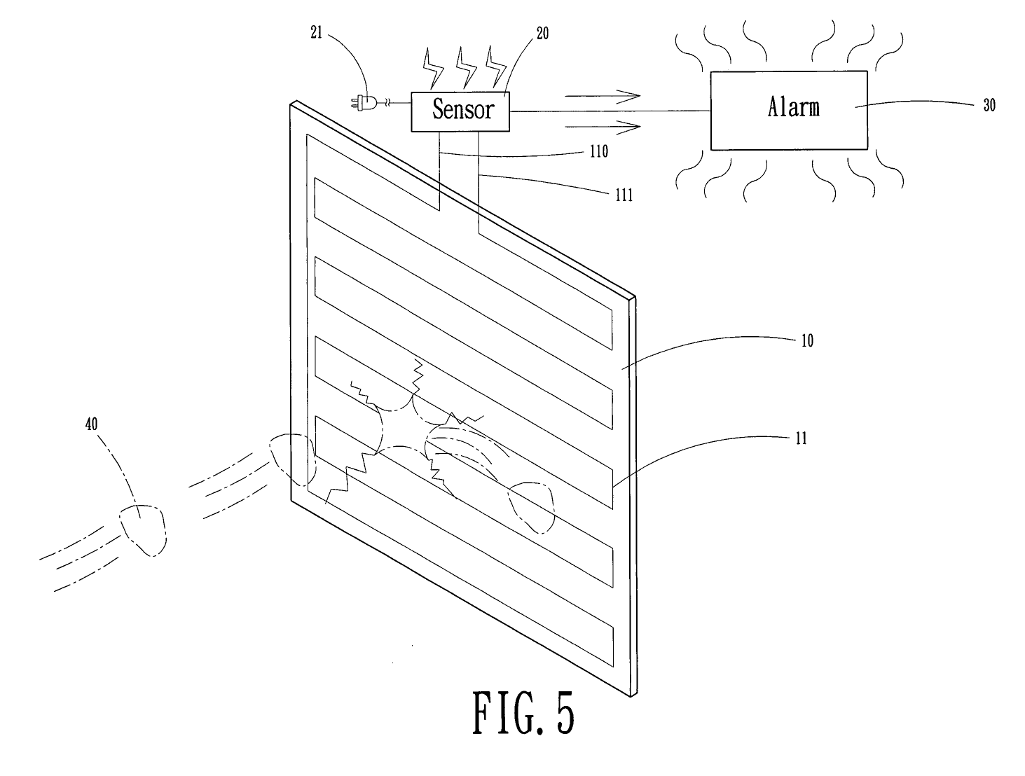

With reference to FIG. 5, the sensing circuit (11) is broken and opened when the fragile object (10) is come to pieces due to a crash formed by a flying object (40). The sensor (20) senses the opened sensing circuit (11) and transmits a signal to the alarm (30). The alarm (30) lights or sounds to warn the guards for achieving a burglarproof objective when receiving the signal from the sensor (20).

Although the invention has been explained in relation to its preferred embodiment, it is to be understood that many other possible modifications and variations can be made without departing from the spirit and scope of the invention as hereinafter claimed.

What is claimed is:

1. A burglarproof sensor for fragile object comprising:
a sensing circuit adapted to be formed on a fragile object, the sensing circuit has a first electrode and a second electrode;
a sensor electrically connected to the first electrode and the second electrode of the sensing circuit for forming a closed circuit, the sensor having an input extending therefrom and adapted to be connected to a power source, the sensor including a voltage regulator, a power indicator, a voltage level comparator, a shunt regular push-pull, an inverter, a load circuit, a trigger circuit and a switching circuit disposed therein for processing the signal from the sensing circuit, the input electrically connected to the voltage regulator and the voltage regular electrically connected to the power indicator and voltage level comparator, the power indicator electrically connected to the voltage level comparator and the voltage level comparator electrically connected to the shunt regulator push-pull, the shunt regulator push-pull electrically connected to the inverter and the inverter electrically connected to the load circuit and the trigger circuit, the load circuit and the trigger circuit respectively electrically connected to the switching circuit; and
an alarm electrically connected to the switching circuit of the sensor;
whereby the sensing circuit is broken and opened when the fragile object is come to pieces due to a crash formed by a flying object such that the sensor senses the opened sensing circuit and transmits a signal to operate the alarm to warn the guards for achieving a burglarproof objective when receiving the signal from the sensor.

2. The burglarproof sensor as claimed in claim 1, wherein the sensing circuit is formed with indium oxide that is achromatic chemical material.

3. The burglarproof sensor as claimed in claim 1, wherein the sensing circuit is formed on the fragile object by plating.

4. The burglarproof sensor as claimed in claim 1, wherein the sensing circuit is formed on the fragile object by evaporation.

5. The burglarproof sensor as claimed in claim 1, wherein the sensing circuit is formed on the fragile object by sputtering.

6. The burglarproof sensor as claimed in claim 1, wherein the sensing circuit is formed on the fragile object by printing.
